(19) United States
(12) Patent Application Publication
(10) Pub. No.: US 2024/0065415 A1
(43) Pub. Date: Feb. 29, 2024

(54) VACUMM BOTTLE WITH A PLURALITY OF LIQUID OUTPUTS

(71) Applicant: Ningbo Jinyu Technology industry Co., Ltd, Ningbo (CN)

(72) Inventor: HANG Cheng, Ningbo (CN)

(21) Appl. No.: 18/136,893

(22) Filed: Apr. 20, 2023

Related U.S. Application Data
(63) Continuation of application No. PCT/CN2022/115935, filed on Aug. 30, 2022.

(51) Int. Cl. A45D 40/00; B65D 5/42; B65D 81/20

(52) U.S. Cl. CPC A45D 40/0075; B65D 5/4212; B65D 81/2015; A45D 2200/051; A45D 2200/054; A45D 2200/10; A45D 2200/20

(57) ABSTRACT

The present invention discloses a vacuum bottle with a plurality of liquid outputs. The present invention includes a bottle body. A rotary liquid output mechanism arranged above the bottle body. The rotary liquid output mechanism includes a rotary massage head, a rotary press head that is fastened with a fastener of the massage head, a down-pressure valve that is matched with the rotary press head for movement, a connection sleeve that is used to limit movement of the down-pressure valve, and a connection tube and pump bodies that are used to pump liquid.

### CROSS-REFERENCE TO RELATED APPLICATIONS

The present application is a continuation of International Application No. PCT/CN2022/115935, with an international filing date of Aug. 30, 2022, which is based upon and claims priority to Chinese Patent Application No. 202210462364.6, filed on Apr. 28, 2022, the entire contents of all of which are incorporated herein by reference.

### TECHNICAL FIELD

The present invention relates to the field of containers of cosmetics and skin care products, in particular to a vacuum bottle with a plurality of liquid outputs.

### BACKGROUND

A vacuum bottle for packaging cosmetics and skin care products usually includes a bottle body and a bottle cap. The bottle body has a storage function. The bottle cap is usually equipped with a liquid output mechanism that is used to squeeze out the cosmetic emulsion in the bottle.

An existing vacuum bottle of the cosmetics or the skin care products is usually equipped with a pressing extrusion type liquid output mechanism. The invention with a patent number of CN201820297054.2 provides a piston downward-moving nozzle system, although a structure is simple, but easy to be damaged in use, with poor use experience. In addition, usage quantity of cosmetics or skin care products needs to be limited in use, but a quantity of liquid output of an existing vacuum bottle is specific every time, resulting that a specific quantity may not be selected according to demands, or the quantity of liquid output is uncertain. Therefore, a required quantity of liquid may not be accurately squeezed.

### SUMMARY

The purpose of the present invention is to provide a vacuum bottle with a plurality of liquid outputs, to resolve the shortcomings in the existing technology.

To achieve the above purpose, the present invention adopts the following technical solution: The bottle includes a bottle body. A rotary liquid output mechanism is arranged above the bottle body. The rotary liquid output mechanism includes a rotary massage head, a rotary press head that is fastened with a fastener of the massage head, a down-pressure valve that is matched with the rotary press head for movement, a connection sleeve that is used to limit movement of the down-pressure valve, and a connection tube and pump bodies that are used to pump liquid.

A ladder-shaped valve spool is arranged at a lateral part of the down-pressure valve, and a liner of the press head which may be clamped into the ladder-shaped valve spool is arranged in the rotary press head.

Preferably, a shoulder sleeve with scale lines is arranged on an outer part of the massage head, and inner convex ribs corresponding to the scale lines are arranged in the shoulder sleeve.

Preferably, an indicator strip is arranged on the outer part of the massage head, and outer convex ribs are arranged below the indicator strip.

Preferably, a first connection buckle is arranged in the massage head, a first connection groove is arranged an outer part of the rotary press head, and the first connection buckle is clamped with the first connection groove.

Preferably, a plurality of groups of ladder-shaped structures are arranged on the ladder-shaped valve spool.

Preferably, a limiting strip is arranged on outside a bottom of the down-pressure valve, and a vertically-arranged limiting groove is arranged in the connection sleeve.

Preferably, there are two groups of pump bodies, the two groups of pump bodies are respectively installed on an upper side and a lower side of the down-pressure valve, and a liquid storage chamber is arranged a top opening of the down-pressure valve.

Preferably, a top end of the connection tube is connected with the massage head in an interference fitting and sealing manner, and a bottom end of the connection tube is connected with the down-pressure valve in the interference fitting and sealing manner.

Preferably, a valve plate is arranged in an inner hole of the massage head, a flexible plate is arranged on the valve plate, and an upper cover is arranged above the massage head.

Preferably, the bottom of the massage head abuts against the connection sleeve.

The present invention has the following beneficial effects:
1. The massage head drives the rotary press head to move, and then drives the down-pressure valve to move downward and compress the pump bodies, so as to pump other liquid in the bottle body. This changes liquid discharge mode, both a liquid output structure and the pump bodies are protectively arranged inside the structure, so that the vacuum bottle is more durable and has longer service life.
2. Because of a liner of the press head and a ladder-shaped valve spool, the down-pressure valve can be pressed down at different heights, so that a specific quantity of liquid can be pumped out. A quantity of liquid output may be indicated by cooperation of the massage head and a shoulder sleeve, so that the vacuum bottle can conveniently and accurately extrude the specific quantity of liquid, and using effect is better.

### BRIEF DESCRIPTION OF DRAWINGS

FIG. 1 is a schematic diagram of a sectional structure according to the present invention;

FIG. 2 is a schematic diagram of an outer structure of a massage head according to the present invention;

FIG. 3 is a schematic diagram of a structure of a massage head according to the present invention;

FIG. 4 is a schematic diagram of a structure of a rotary press head according to the present invention;

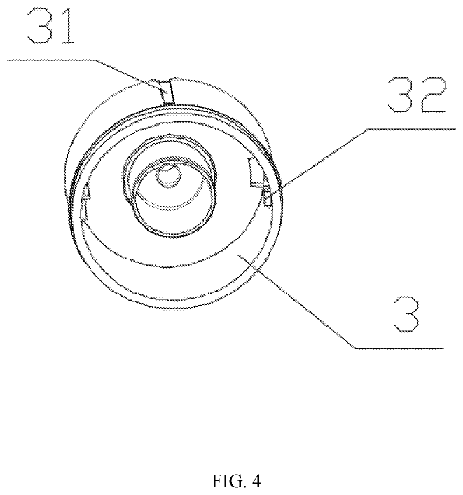

FIG. 5 is a schematic diagram of a structure of a down-pressure valve according to the present invention;

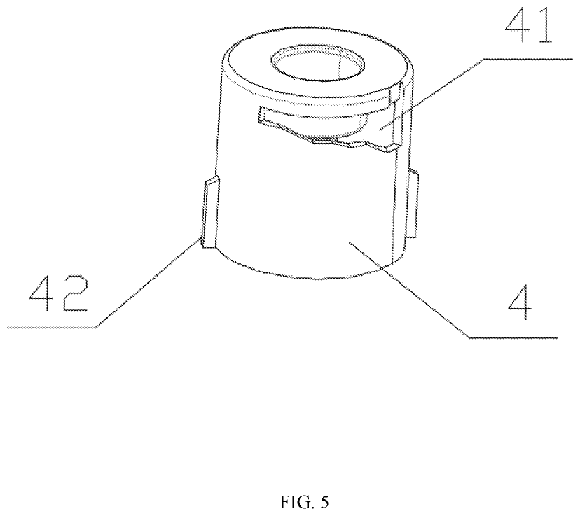

FIG. 6 is a schematic diagram of a structure of a shoulder sleeve according to the present invention; and

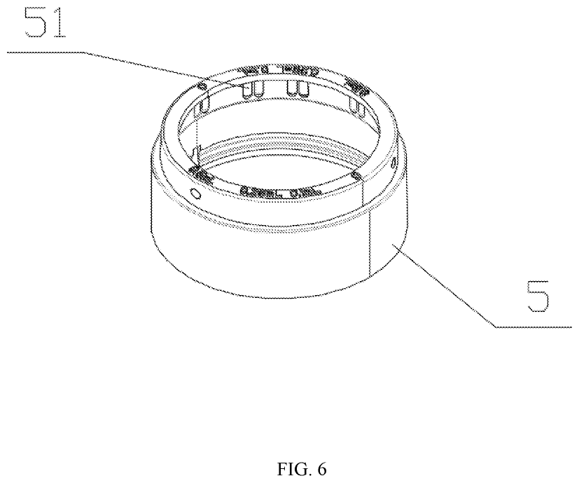

FIG. 7 is a schematic diagram of a structure of a connection sleeve according to the present invention.

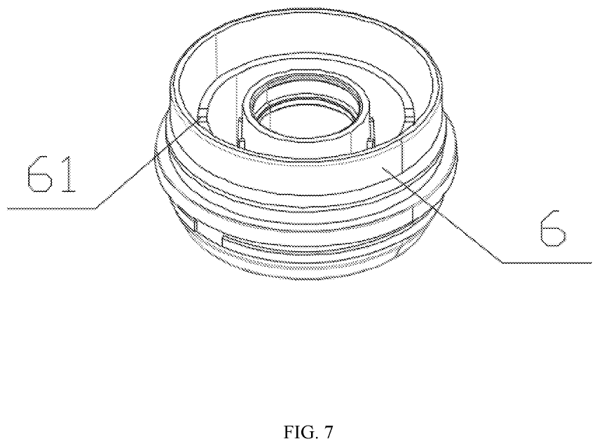

### NUMERALS

1. upper cover; 2. massage head; 21. indicator strip; 22. first connection buckle; 23. outer convex ribs; 3. rotary press head; 31. first connection groove; 32. liner of press head; 4. down-pressure valve; 41. ladder-shaped valve spool; 42. limiting strip; 5. shoulder sleeve; 51. inner convex ribs; 6. connection sleeve; 61. limiting groove; 7. valve plate; 8. connection tube; and 9. pump bodies.

### DESCRIPTION OF EMBODIMENTS

The technical solutions in embodiments of the present invention will be described clearly and completely in the following, with reference to the accompanying drawings in embodiments of the present invention. Apparently, the embodiments described are only a part of the embodiments of the present invention, not all embodiments. All other embodiments obtained by those skilled in the art based on embodiments of the present invention without creative efforts fall within the scope of the present invention.

In the description of the present invention, it should be noted that, orientations or positional relationships indicated by terms such as “center”, “up”, “down”, “left”, “right”, “vertical”, “horizontal”, “inside”, and “outside” are based on orientations or positional relationships shown in drawings are intended for ease of description and simplicity of description only, and do not indicate or imply that the indicated devices or elements must have and must be constructed and operated in a particular orientation, and therefore such terms are not be construed as a limitation to the present invention; and terms such as “first”, “second”, and “third” are only used to describe the purposes, and do not indicate or imply relative importance. In addition, unless otherwise specified and defined explicitly, terms such as “mounted”, “interconnected”, and “connected” are understood in a broad sense, for example, may be fastened, detachably connected, or integrated, may be mechanically connected or electrically connected, may be directly connected or indirectly connected through an intermediate medium, or may be the internally communicated between two elements. A person of ordinary skill in the art can understand specific meanings of these terms in the present invention based on specific situations.

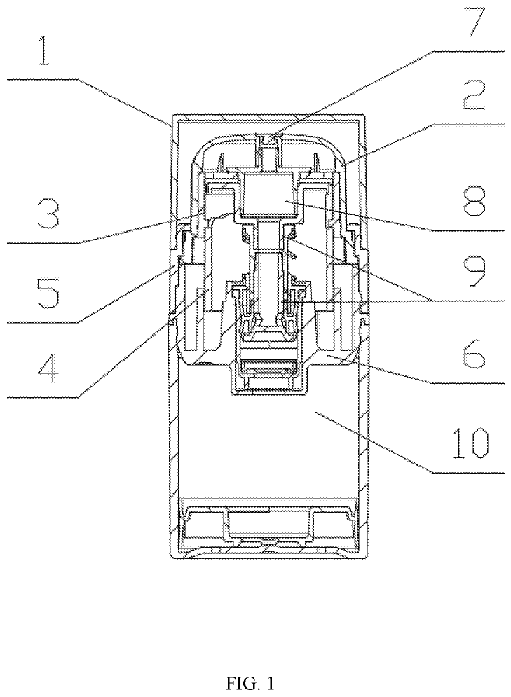

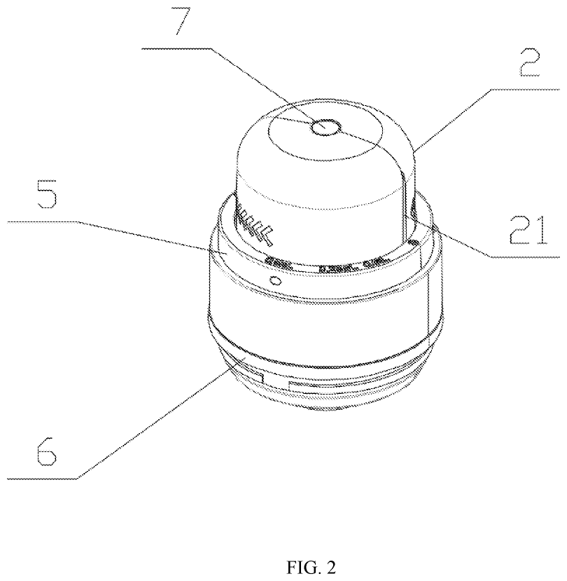

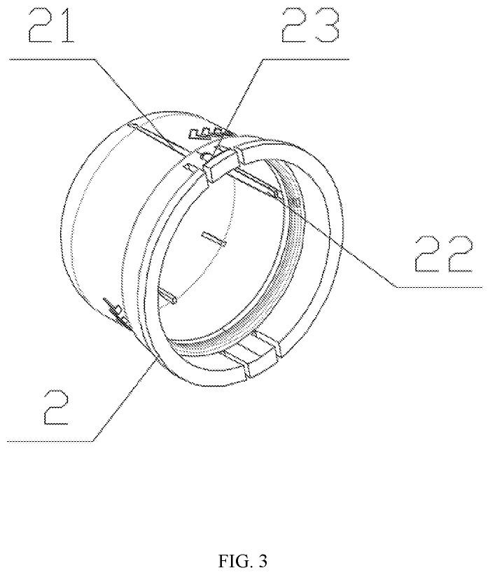

Refer to FIG. 1 to FIG. 3, an embodiment of the present invention includes a bottle body 10. A rotary liquid output mechanism is arranged above the bottle body 10. The rotary liquid output mechanism includes a rotary massage head 2, a rotary press head 3 that is fastened with a fastener of the massage head 2, a down-pressure valve 4 that is matched with the rotary press head 3 for movement, a connection sleeve 6 that is used to limit movement of the down-pressure valve 4, and a connection tube 8 and pump bodies 9 that are used to pump liquid; and

A ladder-shaped valve spool 41 is arranged at a lateral part of the down-pressure valve 4, and a liner 32 of the press head which may be clamped into the ladder-shaped valve spool 41 is arranged in the rotary press head 3.

Further, a shoulder sleeve 5 with scale lines is arranged on an outer part of the massage head 2, and inner convex ribs 51 corresponding to the scale lines are arranged in the shoulder sleeve 5.

Further, an indicator strip 21 is arranged on the outer part of the massage head 2, and outer convex ribs 23 are arranged below the indicator strip 21.

According to the technical solution, the massage head 2 is provided with the scale lines having an indication function, and the indicator strip 21 indicates different scale lines. This is convenient for users to adjust and use. In addition, the outer convex ribs 23 on the outer part of the massage head 2 are matched with the inner convex ribs 51 corresponding to squirting scales in the shoulder sleeve, and there is obvious hand feeling and a sound prompt at each scale, so that a user may conveniently grasp a quantity of liquid output.

Further, a first connection buckle 22 is arranged in the massage head 2, a first connection groove 31 is arranged an outer part of the rotary press head 3, and the first connection buckle 22 is clamped with the first connection groove 31.

According to the technical solution, due to a connection structure of the massage head 2 and the rotary press head 3, when the press head 3 is rotated, the press head may be synchronously rotated with the massage head 2. Therefore, the rotary press head 3 may be rotated by rotating the massage head 2.

Further, a plurality of groups of ladder-shaped structures are arranged on the ladder-shaped valve spool 41.

Further, a limiting strip 42 is arranged on outside a bottom of the down-pressure valve 4, and a vertically-arranged limiting groove 61 is arranged in the connection sleeve 6.

According to the technical solution, when the rotary press head 3 is rotated, the liner 32 of the press head moves on the ladder-shaped valve spool 41. Because limiting groove 61 limits a movement direction of the limiting strip 42, the down-pressure valve 4 may not be rotated with the rotary press head 3, and may only be pressed down. Due to the ladder-shaped structure of the ladder-shaped valve spool 41, rotation amplitudes of the rotary press head 3 are different, and down-pressing heights of the down-pressure valve 4 are also different. This may control different down-pressing heights by controlling a height of each step of the ladder-stepped structure, to squeeze out doses of cosmetics or skin care products. In addition, a plurality of liquid output indicators may be provided by setting different groups of steps. Therefore, in actual use, the ladder-shaped valve spool 41 may be specially designed according to use requirements.

Further, there are two groups of pump bodies 9, the two groups of pump bodies 9 are respectively installed on an upper side and a lower side of the down-pressure valve 4, and a liquid storage chamber is arranged a top opening of the down-pressure valve 4.

According to the technical solution, the rotary press head 3 may be rotated, by rotating the massage head 2 clockwise, following the rotation of the massage head 2, therefore the liner 32 of the press head moves on the ladder-shaped structure of the ladder-shaped valve spool 41. The down-pressure valve 4 moves downward to drive the lower pump bodies 9 to move downward, so as to open pistons in pump cores. In this case, liquid enters the liquid storage chamber at the top of the down-pressure valve 4 via a center hole of the valve from a valve needle hole. When the down-pressure valve 4 moves downward, pistons in the upper pump bodies 9 do not move, space of the liquid storage chamber at the top of the down-pressure valve 4 is enlarged, and a specific quantity of liquid is stored in the liquid storage chamber. In this case, the massage head 2 is rotated counterclockwise to “0”, the liner 32 of the press head moves down along the ladder-shaped structure of the ladder-shaped valve spool 41, and the down-pressure valve 4 rises to close the pistons in the pump cores of the lower pump bodies 9 to close. As the down-pressure valve 4 rises, the space of the liquid storage chamber at the top is compressed, and liquid is pumped out from a hole at the tops of the pistons of the upper pump bodies 9, to squeeze out the specific quantity of liquid.

Further, a top end of the connection tube 8 is connected with the massage head 2 in an interference fitting and sealing manner, and a bottom end of the connection tube 8 is connected with the down-pressure valve 4 in the interference fitting and sealing manner.

Further, a valve plate 7 is arranged in an inner hole of the massage head 2, a flexible plate is arranged on the valve plate 7, and an upper cover 1 is arranged above the massage head 2.

According to the technical solution, a buckling position of the valve plate 7 is matched with an inner hole at the top of the massage head 2, and an liquid outlet may be sealed after assembly. When liquid is squeezed out, the flexible plate at the top of the valve plate 7 is punched out, and liquid is squeezed out from the periphery of the valve plate 7.

Further, the bottom of the massage head 2 abuts against the connection sleeve 6.

According to the technical solution, the massage head 2 may only be rotated but may not be pressed down under limitation of the connection sleeve 6.

Operating principles are: The rotary press head 3 may be rotated, by rotating the massage head 2 clockwise, following the rotation of the massage head 2, therefore the liner 32 of the press head moves on the ladder-shaped structure of the ladder-shaped valve spool 41. The down-pressure valve 4 moves downward to drive the lower pump bodies 9 to move downward, so as to open pistons in pump cores. In this case, liquid enters the liquid storage chamber at the top of the down-pressure valve 4 via a center hole of the valve from a valve needle hole. When the down-pressure valve 4 moves downward, pistons in the upper pump bodies 9 do not move, space of the liquid storage chamber at the top of the down-pressure valve 4 is enlarged, and a specific quantity of liquid is stored in the liquid storage chamber. In this case, the massage head 2 is rotated counterclockwise to “0”, the liner 32 of the press head moves down along the ladder-shaped structure of the ladder-shaped valve spool 41, and the down-pressure valve 4 rises to close the pistons in the pump cores of the lower pump bodies 9 to close. As the down-pressure valve 4 rises, the space of the liquid storage chamber at the top is compressed, and liquid is pumped out from a hole at the tops of the pistons of the upper pump bodies 9, to squeeze out the specific quantity of liquid.

Finally, it should be noted that the foregoing embodiments are merely intended for describing the technical solutions of the present invention, instead of limiting the present invention. Although the present invention is described in detail with reference to the foregoing embodiments, persons of ordinary skill in the art should understands that they may still make modifications to technical solution described in the foregoing embodiments or equivalent replacements to some technical features thereof. Any modifications, equivalents, and improvements made within the spirit and principles of the present invention, all fall within the scope of protection of the present invention.

What is claimed is:

1. A vacuum bottle with a plurality of liquid outputs, comprising a bottle body, wherein a rotary liquid output mechanism is arranged above the bottle body; the rotary liquid output mechanism comprises a rotary massage head, a rotary press head that is fastened with a fastener of the massage head, a down-pressure valve that is matched with the rotary press head for movement, a connection sleeve that is used to limit movement of the down-pressure valve, and a connection tube and pump bodies that are used to pump liquid; and
a ladder-shaped valve spool is arranged at a lateral part of the down-pressure valve, and a liner of the press head which may be clamped into the ladder-shaped valve spool is arranged in the rotary press head.

2. The vacuum bottle of claim 1, wherein a shoulder sleeve with scale lines is arranged on an outer part of the massage head, and inner convex ribs corresponding to the scale lines are arranged in the shoulder sleeve.

3. The vacuum bottle of claim 1, wherein an indicator strip is arranged on the outer part of the massage head, and outer convex ribs are arranged below the indicator strip.

4. The vacuum bottle of claim 1, wherein a first connection buckle is arranged in the massage head, a first connection groove is arranged an outer part of the rotary press head, and the first connection buckle is clamped with the first connection groove.

5. The vacuum bottle of claim 1, wherein a plurality of groups of ladder-shaped structures are arranged on the ladder-shaped valve spool.

6. The vacuum bottle of claim 1, wherein a limiting strip is arranged on outside a bottom of the down-pressure valve, and a vertically-arranged limiting groove is arranged in the connection sleeve.

7. The vacuum bottle of claim 1, wherein there are two groups of pump bodies, the two groups of pump bodies are respectively installed on an upper side and a lower side of the down-pressure valve, and a liquid storage chamber is arranged a top opening of the down-pressure valve.

8. The vacuum bottle of claim 1, wherein a top end of the connection tube is connected with the massage head in an interference fitting and sealing manner, and a bottom end of the connection tube is connected with the down-pressure valve in the interference fitting and sealing manner.

9. The vacuum bottle of claim 1, wherein a valve plate is arranged in an inner hole of the massage head, a flexible plate is arranged on the valve plate, and an upper cover is arranged above the massage head.

10. The vacuum bottle of claim 1, wherein the bottom of the massage head abuts against the connection sleeve.
